(19) United States
(12) Patent Application Publication
(10) Pub. No.: US 2007/0221686 A1
(43) Pub. Date: Sep. 27, 2007

(54) Liquid pump dispenser

(75) Inventor: Hae Dong Bae, Anyang city (KR)

Correspondence Address: MAYER, BROWN, ROWE & MAW LLP, 1909 K STREET, N.W., WASHINGTON, DC, 20006, US

(73) Assignee: Taesung Industrial Co., Ltd.

(21) Appl. No.: 11/508,954

(22) Filed: Aug. 24, 2006

(30) Foreign Application Priority Data
Mar. 27, 2006 (KR) 10-2006-0027385

(51) Int. Cl. G01F 11/00

(52) U.S. Cl. 222/409

(57) ABSTRACT

Disclosed is A liquid pump dispenser. A fluid path opening and closing section has a rod-shaped body part which is installed in a discharge guide path and a sliding guide groove of a push button, a wing part which is formed around the body part to be brought into close contact with an inner surface of the sliding guide groove, and a return spring which is disposed in the sliding guide groove to bias the wing part toward the discharge guide path. The body part is retracted to an opening position for opening the discharge guide path with respect to the outside by pressure applied from pumped liquid entering the discharge guide path to the wing part and is extended to a closing position for closing the discharge guide path with respect to the outside by pressure applied from the return spring to the wing part.

### BACKGROUND OF THE INVENTION

1. Field of the Invention

The present invention relates to a liquid pump dispenser, and more particularly to a liquid pump dispenser for discharging a liquid, such as cosmetics, out of a liquid container through pumping.

2. Description of the Prior Art

A conventional liquid pump dispenser, which has been known and used in the art, is coupled with an upper end of a liquid container to discharge liquid, such as cosmetics, out of the liquid container through pumping. As used here, the term ‘liquid’ includes substance such as cream, which has a viscosity sufficient to allow the substance to be pumped.

FIG. 8 is an assembled cross-sectional view illustrating a conventional liquid pump dispenser.

Referring to FIG. 8, the conventional liquid pump dispenser comprises a cap 110 which is coupled with the upper end of a liquid container 201 (see FIG. 1), a pumping operation section 120 which has a tubular cylinder 121 coupled with the cap 110 and a piston 130, a push button 140 which is coupled with the upper end of the piston 130, and a nozzle 150 which is installed through the front portion of the push button 140.

The cap 110 is threadedly coupled with the upper end (neck part) of the liquid container 201.

In addition to the cylinder 121 and the piston 130, the pumping operation section 120 has a ball valve 122 which is received in the cylinder 121 to be placed adjacent to the lower end opening of the cylinder 121, a sealing ring 123 which is installed so that its outer surface is brought into close contact with the inner surface of the cylinder 121, and a pumping return spring 124 which is placed between the lower end of the piston 130 and the ball valve 122.

The upper portion of the cylinder 121 is interference-fitted into the cap 110.

The piston 130 is composed of a tubular operation piston 131 which is installed to pass through the cap 110, and an opening and closing piston 132 which is installed to pass through the sealing ring 123.

The opening and closing piston 132 has a piston leg part 132a which defines four groove-shaped pumping paths 132b on the outer surface thereof, and a piston head part 132c which is formed on the lower end of the piston leg part 132a.

The pumping return spring 124 is supported via a pair of support members 124a by the lower end of the piston head part 132c and the inside lower end portion of the cylinder 121.

The pumping operation section 120 constructed as mentioned above operates as described below.

As pressure is downwardly applied to the operation piston 131, the liquid existing inside the cylinder 121 is pumped through the pumping paths 132b.

If the pressure applied to the operation piston 131 is released, the pumping operation through the pumping paths 132b is interrupted, and the liquid accommodated in the liquid container 201 is introduced into the cylinder 121.

The push button 140 has a button body part 141, a cylindrical fluid path connection part 142 which is formed on the lower surface of the button body part 141, and an outer cylindrical wall part 143 which downwardly extends from the button body part 141 to surround the cylindrical fluid path connection part 142.

A discharge guide path 141b is linearly defined in the button body part 141 such that the left end of the discharge guide path 141b is opened to the outside through the left side surface of the button body part 141.

Further, a discharge connection hole 141a is defined in the button body part 141 to interconnect the cylindrical fluid path connection part 142 and the discharge guide path 141b. The discharge connection hole 141a is located at the center portion of the cylindrical fluid path connection part 142. The discharge connection hole 141a and the cylindrical fluid path connection part 142 cooperate with each other to define a discharge connection path.

A plurality of stopper projections 142a is formed at the bottom of the cylindrical fluid path connection part 142 to be positioned around the discharge connection hole 141a.

The push button 140 constructed as mentioned above is coupled with the upper end of the operation piston 131 such that the cylindrical fluid path connection part 142 communicates with the pumping paths 132b.

As the push button 140 is coupled with the upper end of the operation piston 131, if the push button 140 is pushed, pressure is downwardly applied to the operation piston 131, and if the operation piston 131 is raised, the push button 140 is also raised to its original position.

The nozzle 150 is coupled with the front portion of push button 140 to communicate with the discharge guide path 141b.

However, in the conventional liquid pump dispenser, a problem is caused in that, since the pumping paths 132b are opened or exposed to the outside in a state in which the discharge of liquid to the outside is interrupted, an air path is created between the outside and the pumping paths 132b.

Because of the fact that the air path is created between the outside and the pumping paths 132b due to contact with air leaked through the air path, the liquid accommodated in the liquid container 201 is likely to be changed in quality. Also, due to evaporation of moisture through the air path, the liquid existing in the nozzle 150, the discharge guide path 141b, the discharge connection path 141a and 142, and the pumping paths 132b are likely to be solidified, degrading the discharging function of the liquid pump dispenser. Specifically, in a case where the liquid existing in the nozzle 150 or the front end of the discharge guide path 141b is solidified, the discharging function of the liquid pump dispenser can be significantly deteriorated.

Further, a drawback is provoked in that, when the discharge of the liquid is interrupted, because the liquid having filled the nozzle 150 and the discharge guide path 141b remains as it is, the amount of liquid remaining in the nozzle 150 and the discharge guide path 141b increases.

### SUMMARY OF THE INVENTION

Accordingly, the present invention has been made to solve the above-mentioned problems occurring in the prior art, and an object of the present invention is to provide a liquid pump dispenser which can decrease the amount of liquid remaining in a discharge guide path and can close pumping paths with respect to the outside in a state where the discharge of liquid to the outside is interrupted.

In order to achieve the above object, according to one aspect of the present invention, there is provided a liquid pump dispenser comprising: a cap formed with a support tube at a center portion thereof and coupled with an upper end of a liquid container to allow the support tube to be aligned with an opening of the liquid container; a pumping operation section including a tubular cylinder, an upper portion of which is coupled with the cap to be brought into close contact with an outer surface of the support tube, and a piston which defines pumping paths extending in a lengthwise direction thereof and is mounted to allow the pumping paths to be positioned in the support tube, the pumping operation section operating in a manner such that liquid in the liquid container is introduced into the cylinder when the piston is raised and the liquid introduced into the cylinder is pumped through the pumping paths when the piston is lowered; a push button defined with a linear discharge guide path one end of which is opened through a side surface of the push button and with a discharge connection path one end of which is opened through a lower surface of the push button and which communicates with the discharge guide path, the push button being coupled with an upper end of the piston such that the discharge connection path communicates with the pumping paths, the push button having a sliding guide groove aligned with the discharge guide path and a vent hole communicating with the sliding guide groove; and a fluid path opening and closing section including a rod-shaped opening and closing body part which is formed to have a cross-sectional area smaller than that of the discharge guide path and is installed in the discharge guide path and the sliding guide groove, an opening and closing wing part which is formed around an entire circumference of the opening and closing body part to be brought into close contact with an inner surface of the sliding guide groove, and an opening and closing return spring which is disposed in the sliding guide groove to bias the opening and closing wing part toward the discharge guide path, the fluid path opening and closing section operating in a manner such that the opening and closing body part is retracted to an opening position for opening the discharge guide path with respect to the outside by pressure applied from pumped liquid entering the discharge guide path to the opening and closing wing part and is extended to a closing position for closing the discharge guide path with respect to the outside by pressure applied from the opening and closing return spring to the opening and closing wing part.

According to another aspect of the present invention, the liquid pump dispenser further comprises a nozzle on an inner surface of which guide ribs for guiding linear movement of the opening and closing body part are formed in a lengthwise direction of the nozzle to stably maintain the linear movement of the opening and closing body part and which is installed through a front portion of the push button to communicate with the discharge guide path, and the fluid path opening and closing section is linearly moved to open and close an opening of the nozzle.

According to still another aspect of the present invention, the other end of the discharge connection path which communicates with the pumping paths has a larger cross-sectional area than one end of the discharge connection path which communicates with the discharge guide path, to increase the pressure applied from the pumped liquid to the opening and closing wing part.

### BRIEF DESCRIPTION OF THE DRAWINGS

The above and other objects, features and advantages of the present invention will be more apparent from the following detailed description when taken in conjunction with the accompanying drawings, in which:

FIG. 1 is an assembled perspective view illustrating a liquid pump dispenser in accordance with an embodiment of the present invention;

FIG. 2 is an exploded perspective view illustrating the liquid pump dispenser in accordance with an embodiment of the present invention;

FIG. 3 is an assembled cross-sectional view illustrating the liquid pump dispenser in accordance with an embodiment of the present invention;

FIG. 4 is a bottom view of the push button shown in FIG. 3;

FIG. 5 is a cross-sectional view of the nozzle shown in FIG. 3;

FIGS. 6 and 7 are cross-sectional views illustrating operations of the liquid pump dispenser in accordance with an embodiment of the present invention; and

FIG. 8 is an assembled cross-sectional view illustrating a conventional liquid pump dispenser.

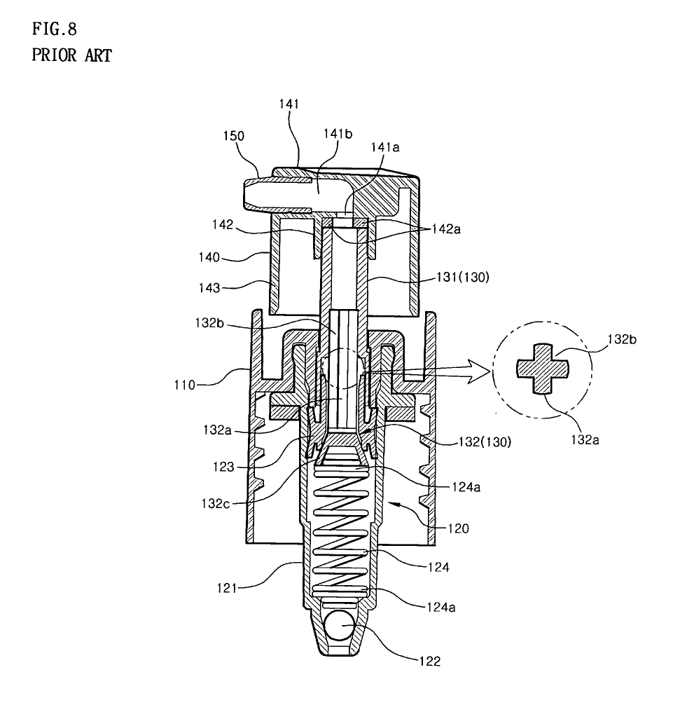

### DETAILED DESCRIPTION OF THE PREFERRED EMBODIMENTS

Reference will now be made in greater detail to an embodiment of the invention, an example of which is illustrated in the accompanying drawings.

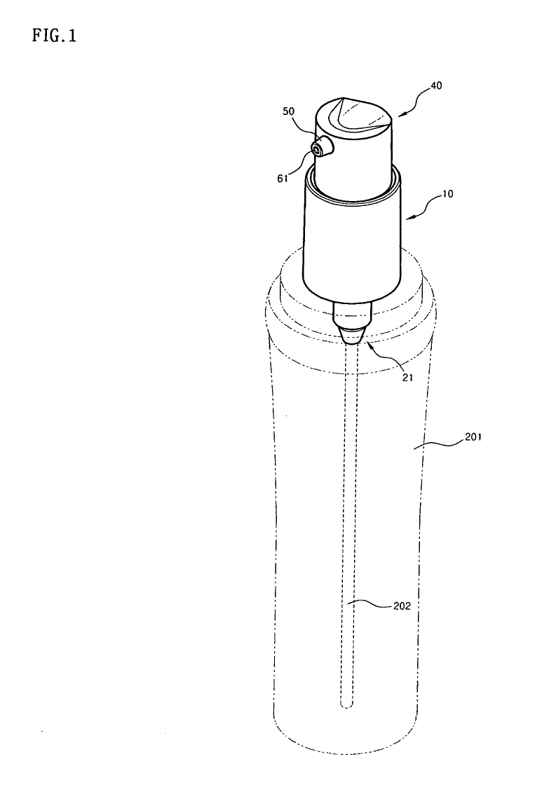

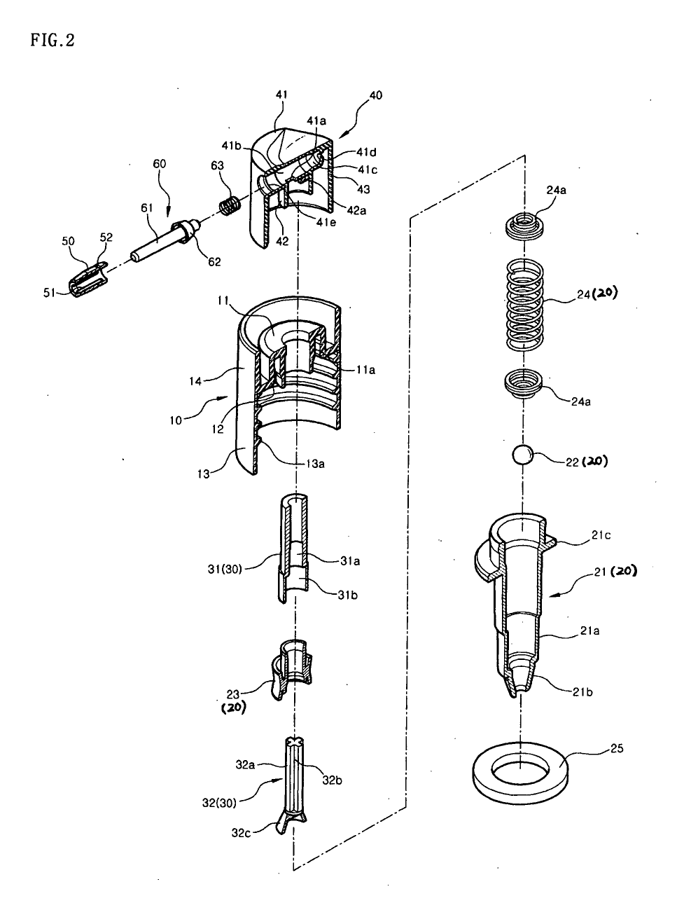

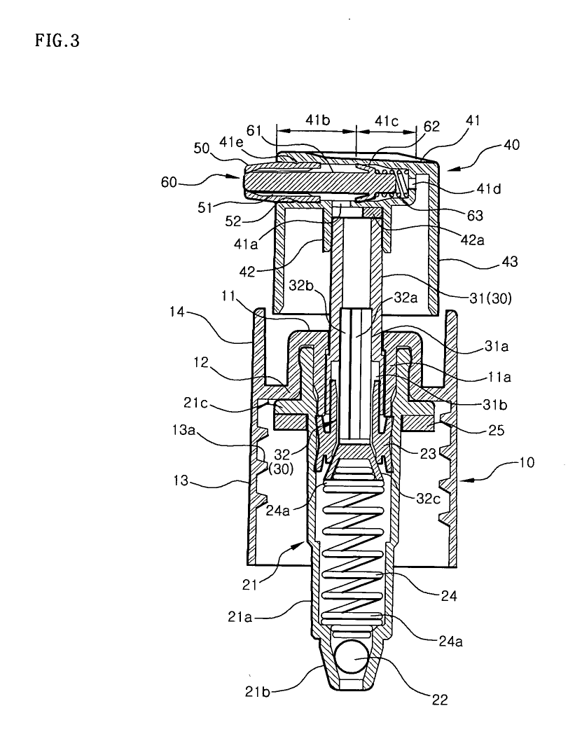

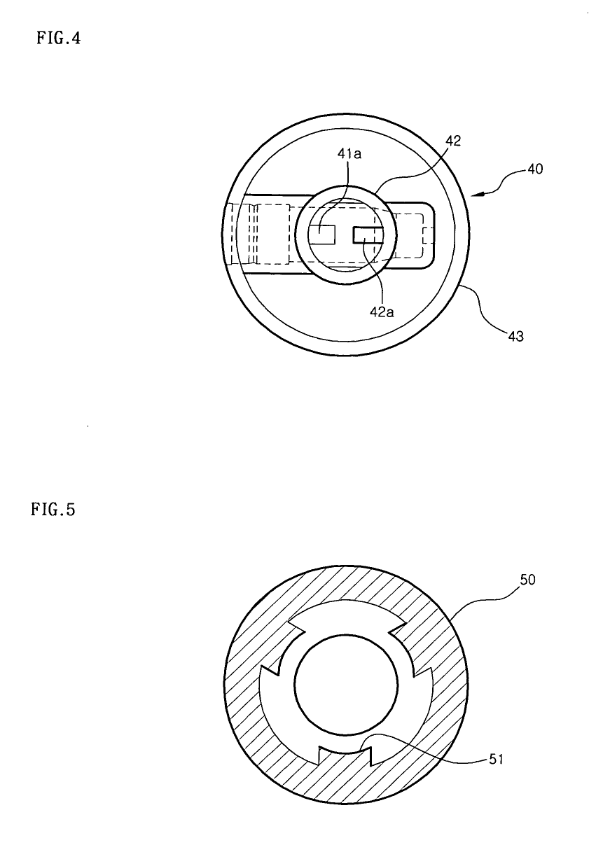

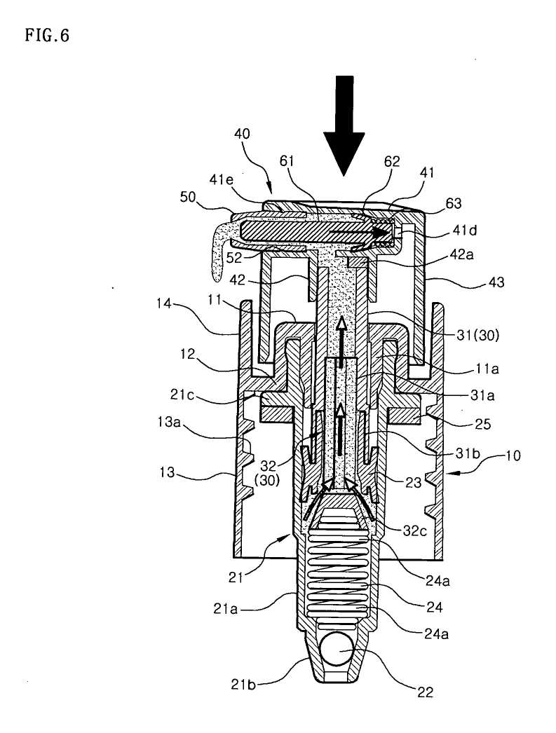

FIG. 1 is an assembled perspective view illustrating a liquid pump dispenser in accordance with an embodiment of the present invention, FIG. 2 is an exploded perspective view illustrating the liquid pump dispenser in accordance with the embodiment of the present invention, FIG. 3 is an assembled cross-sectional view illustrating the liquid pump dispenser in accordance with the embodiment of the present invention, FIG. 4 is a bottom view of the push button shown in FIG. 3, and FIG. 5 is a cross-sectional view of the nozzle shown in FIG. 3.

Referring to the drawings, the liquid pump dispenser in accordance with the embodiment of the present invention comprises a cap 10 which is coupled with the upper end of a liquid container 201, a pumping operation section 20 which has a tubular cylinder 21 coupled with the cap 10 and a piston 30, a push button 40 which is coupled with the upper end of the piston 30, a nozzle 50 which is installed through the front portion of the push button 40, and a fluid path opening and closing section 60 which is installed in the push button 40.

The cap 10 comprises a ceiling part 11 which is positioned at the center portion of the cap 10 and from which a support tube 11a extends downward, a connection part 12 which extends downward in the shape of a step, a container coupling wall part 13 which is bent downward from the connection part 12, and a guide wall part 14 which is bent upward from the connection part 12.

An internal thread 13a is formed on the inner surface of the container coupling wall part 13.

The cap 10 is threadedly coupled with the upper end (neck part) of the liquid container 201 such that the support tube 11a is aligned with the opening of the liquid container 201.

In addition to the cylinder 21 and the piston 30, the pumping operation section 20 has a ball valve 22 which is received in the cylinder 21 to be placed adjacent to the lower end opening of the cylinder 21, a sealing ring 23 which is installed so that its outer surface is brought into close contact with the inner surface of the cylinder 21, and a pumping return spring 24 which is disposed between the lower end of the piston 30 and the ball valve 22.

A support flange 21c is formed on the outer surface of the upper portion of the cylinder 21 to extend outward, and a small diameter cylinder part 21a and a tapered cylinder part 21b are continuously formed on the lower portion of the cylinder 21.

The cylinder 21 is coupled with the cap 10 such that the upper portion of the cylinder 21 above the support flange 21c is brought close to the outer surface of the support tube 11a and the support flange 21c comes into contact with the connection part 12.

A leakage prevention ring 25 is mounted around the cylinder 21 to be brought into contact with the lower surface of the support flange 21c.

The piston 30 is composed of a tubular operation piston 31 which is installed to pass through the support tube 11a, and an opening and closing piston 32 which is installed to pass through the sealing ring 23.

The operation piston 31 is formed with a piston pressing large diameter part 31a on the inside middle portion thereof and with a ring pressing large diameter part 31b on the inside lower portion thereof.

The opening and closing piston 32 has a piston leg part 32a which defines four groove-shaped pumping paths 32b on the outer surface thereof, and a piston head part 32c which is formed on the lower end of the piston leg part 32a.

The opening and closing piston 32 is installed in a manner such that the outer surface of the piston head part 32c is brought into contact with the inner surface of the sealing ring 23, and the upper end of the piston leg part 32a is brought into contact with the piston pressing large diameter part 31a. By this fact, the pumping paths 32b are positioned in the support tube 11a.

The pumping return spring 24 is supported via a pair of support members 24a by the lower end of the piston head part 32c and the tapered cylinder part 21b.

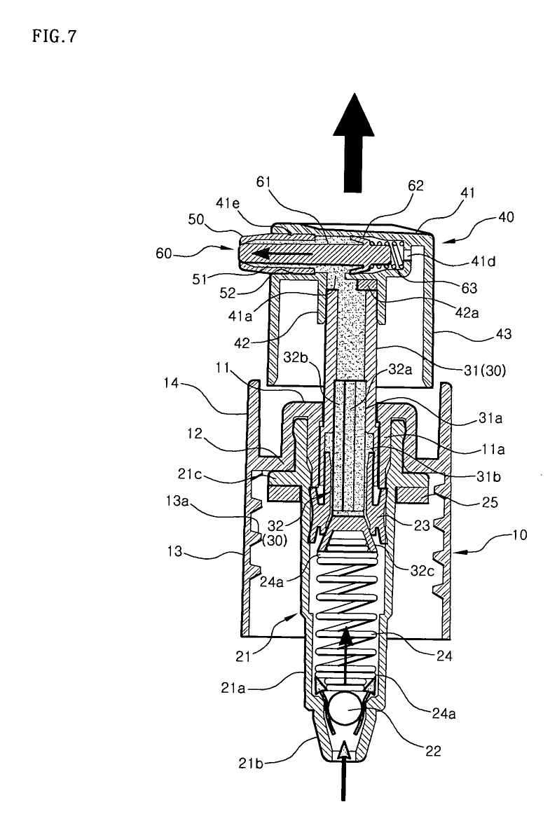

The pumping operation section 20 constructed as mentioned above operates as described below (see FIGS. 6 and 7).

As pressure is downwardly applied to the operation piston 31, the operation piston 31 and the opening and closing piston 32 are lowered.

As the opening and closing piston 32 is lowered, a gap is produced between the sealing ring 23 and the piston head part 32c, and the liquid in the cylinder 21 is pumped through the pumping paths 32b.

If the operation piston 31 is lowered and is brought into contact with the sealing ring 23, the sealing ring 23 is also lowered together with the operation piston 31. While the sealing ring 23 is lowered in this way, the pumping operation through the pumping paths 32b is continued.

While the opening and closing piston 32 is lowered, the pumping return spring 24 is compressed to accumulate elastic force.

If the pressure applied to the operation piston 31 is released, the opening and closing piston 32 is raised together with the operation piston 31 by the elastic force of the pumping return spring 24.

As the opening and closing piston 32 is raised and the piston head part 32c comes into contact with the sealing ring 23, the gap between the sealing ring 23 and the piston head part 32c vanishes, and the pumping operation through the pumping paths 32b is interrupted.

After pumping of the liquid is interrupted, the sealing ring 23, the opening and closing piston 32 and the operation piston 31 are raised together.

As the sealing ring 23 and the opening and closing piston 32 are raised together, negative pressure is induced in the cylinder 21, and the ball valve 22 is raised such that the lower end opening of the cylinder 21 is opened.

As the ball valve 22 is released from the lower end opening of the cylinder 21, the liquid accommodated in the liquid container 201 is introduced into the cylinder 21 through a suction tube 202.

As the liquid is introduced into the cylinder 21, the negative pressure in the cylinder 21 gradually decreases.

If the negative pressure in the cylinder 21 vanishes, the ball valve 22 is lowered to its original position to close again the lower end opening of the cylinder 21.

With the sealing ring 23 returned to its original position, the opening and closing piston 32 and the operation piston 31 are raised to their original positions.

The push button 40 has a button body part 41, a cylindrical fluid path connection part 42 which is formed on the lower surface of the button body part 41, and an outer cylindrical wall part 43 which downwardly extends from the button body part 41 to surround the cylindrical fluid path connection part 42.

A discharge guide path 41b is linearly defined in the button body part 41 such that the left end of the discharge guide path 41b is opened to the outside through the left side surface of the button body part 41.

Further, a discharge connection hole 41a is defined in the button body part 41 to interconnect the cylindrical fluid path connection part 42 and the discharge guide path 41b. The discharge connection hole 41a is placed at a position deviating from the center portion of the cylindrical fluid path connection part 42 toward the nozzle 50 and to have a cross-sectional area smaller than that of the cylindrical fluid path connection part 42. As the discharge connection hole 41a has a cross-sectional area smaller than that of the cylindrical fluid path connection part 42, it is possible to increase the pressure which is applied from the pumped liquid to the opening and closing wing part 62 of the fluid path opening and closing section 60. The discharge connection hole 41a and the cylindrical fluid path connection part 42 cooperate with each other to define a discharge connection path.

In the button body part 41, a sliding guide groove 41c is aligned with the discharge guide path 41b, and a vent hole 41d communicates with the sliding guide groove 41c.

A stopper projection 42a is formed at the bottom of the cylindrical fluid path connection part 42 to be deviated from the discharge connection hole 41a.

The push button 40 constructed as mentioned above is coupled with the upper end of the operation piston 31 such that the cylindrical fluid path connection part 42 communicates with the pumping paths 32b.

As the push button 40 is coupled with the upper end of the operation piston 31, if the push button 40 is pushed downward, pressure is downwardly applied to the operation piston 31, and if the operation piston 31 is raised, the push button 40 is also raised to an original position.

In the nozzle 50, three guide ribs 51 for guiding the linear movement of the opening and closing body part 61 of the fluid path opening and closing section 60 are formed on the inner surface of the nozzle 50 in the lengthwise direction of the nozzle 50. As the guide ribs 51 are formed in the nozzle 50, the linear movement of the opening and closing body part 61 of the fluid path opening and closing section 60 as will be described later can be stably maintained.

The nozzle 50 constructed as mentioned above is installed through the front portion of the push button 40 to communicate with the discharge guide path 41b. The coupled state of the nozzle 50 with respect to the push button 40 is stably maintained due to the presence of an annular fastening protrusion 41e which is formed on the inner surface of the discharge guide path 41b and an annular fastening groove 52 which is defined on the outer surface of the nozzle 50.

The fluid path opening and closing section 60 comprises the rod-shaped opening and closing body part 61 which is installed in the discharge guide path 41b and the sliding guide groove 41c, an opening and closing wing part 62 which is formed around the entire circumference of the opening and closing body part 61, and an opening and closing return spring 63 which is disposed in the sliding guide groove 41c to bias the opening and closing wing part 62 toward the discharge guide path 41b.

The opening and closing body part 61 is formed to have a cross-sectional area smaller than that of the discharge guide path 41b, that is, to be fitted inward of the guide ribs 51.

The opening and closing wing part 62 is formed to be brought into close contact with the inner surface of the sliding guide groove 41c. The opening and closing wing part 62 is formed integrally with the opening and closing body part 61 using suitable material such as linear low density polyethylene.

The fluid path opening and closing section 60 constructed as mentioned above operates as described below (see FIGS. 6 and 7).

As the operation piston 31 is pressed downward, the liquid pumped into the pumping paths 32b continuously enters the discharge guide path 41b through the cylindrical fluid path connection part 42 and the discharge connection hole 41a.

The opening and closing body part 61 is retracted by the pressure which is applied from the liquid entering the discharge guide path 41b to the opening and closing wing part 62.

While the opening and closing body part 61 is retracted, air is discharged through the vent hole 41d, and the opening and closing return spring 63 is compressed and accumulates elastic force.

As the opening and closing body part 61 is retracted, the opening of the nozzle 50 is opened, and the discharge guide path 41b is opened with respect to the outside.

If the opening of the nozzle 50 is opened, the liquid is discharged to the outside through the space defined between the guide ribs 51.

Meanwhile, if the push button 40 is released, the operation piston 31 is raised to the original position, and the pumping operation through the pumping paths 32b is interrupted.

If the pumping operation through the pumping paths 32b is interrupted, the opening and closing body part 61 is extended, that is, moved forward by the pressure which is applied from the opening and closing return spring 63 to the opening and closing wing part 62. Here, while the opening and closing body part 61 is moved forward, air is introduced into the sliding guide groove 41c through the vent hole 41d.

As the opening and closing body part 62 is moved forward beyond the guide ribs 51, the liquid remaining in the front end of the discharge guide path 41b is discharged to the outside through the nozzle 50.

The forward movement of the opening and closing body part 61 continues until the front end of the opening and closing body part 61 closes the opening of the nozzle 50.

If the opening of the nozzle 50 is closed, the discharge guide path 41b is closed with respect to the outside.

If the opening of the nozzle 50 is closed, the discharge of the liquid to the outside is interrupted until the push button 40 is pressed again.

In the above-described embodiment of the present invention, due to the fact that the fluid path opening and closing section 60 for opening and closing the discharge guide path 41b in conformity with the liquid pumping operation is provided, the pumping paths 32b are closed with respect to the outside with the discharge of liquid being interrupted. Accordingly, it is possible to prevent the liquid accommodated in the liquid container 201 from being changed in quality due to contact with air and to prevent the liquid remaining in the nozzle 50, the discharge guide path 41b, the cylindrical fluid path connection part 42, the discharge connection hole 41a or the pumping paths 42b from being solidified, thereby hindering the liquid discharge operation.

Further, when the opening and closing body part 61 is moved forward beyond the guide ribs 51, since the liquid remaining in the front end of the discharge guide path 41b is discharged by the opening and closing body part 61, the amount of liquid remaining in the front end of the discharge guide path 41b can be decreased.

As is apparent from the above descriptions, the liquid pump dispenser according to the present invention provides advantages in that, since pumping paths are closed with respect to the outside with the discharge of liquid being interrupted, it is possible to prevent the liquid accommodated in a liquid container from being changed in quality due to contact with air and to prevent the liquid remaining in a discharge guide path, the discharge connection path or the pumping paths from being solidified, thereby hindering the liquid discharge operation. Further, the amount of liquid remaining in the discharge guide path can be decreased.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A liquid pump dispenser comprising:
a cap formed with a support tube at a center portion thereof and coupled with an upper end of a liquid container to allow the support tube to be aligned with an opening of the liquid container;
a pumping operation section including a tubular cylinder, an upper portion of which is coupled with the cap to be brought into close contact with an outer surface of the support tube, and a piston which defines pumping paths extending in a lengthwise direction thereof and is mounted to allow the pumping paths to be positioned in the support tube, the pumping operation section operating in a manner such that liquid in the liquid container is introduced into the cylinder when the piston is raised and the liquid introduced into the cylinder is pumped through the pumping paths when the piston is lowered;
a push button defined with a linear discharge guide path one end of which is opened through a side surface of the push button and with a discharge connection path one end of which is opened through a lower surface of the push button and which communicates with the discharge guide path, the push button being coupled with an upper end of the piston such that the discharge connection path communicates with the pumping paths, the push button having a sliding guide groove aligned with the discharge guide path and a vent hole communicating with the sliding guide groove; and
a fluid path opening and closing section including a rod-shaped opening and closing body part which is formed to have a cross-sectional area smaller than that of the discharge guide path and is installed in the discharge guide path and the sliding guide groove, an opening and closing wing part which is formed around an entire circumference of the opening and closing body part to be brought into close contact with an inner surface of the sliding guide groove, and an opening and closing return spring which is disposed in the sliding guide groove to bias the opening and closing wing part toward the discharge guide path, the fluid path opening and closing section operating in a manner such that the opening and closing body part is retracted to an opening position for opening the discharge guide path with respect to the outside by pressure applied from pumped liquid entering the discharge guide path to the opening and closing wing part and is extended to a closing position for closing the discharge guide path with respect to the outside by pressure applied from the opening and closing return spring to the opening and closing wing part.

2. The liquid pump dispenser as claimed in claim 1, further comprising a nozzle, on an inner surface of which guide ribs for guiding linear movement of the opening and closing body part are formed in a lengthwise direction of the nozzle and which is installed through a front portion of the push button to communicate with the discharge guide path, p1 wherein the fluid path opening and closing section is linearly moved to open and close an opening of the nozzle.

3. The liquid pump dispenser as claimed in claims 1 or 2, wherein the other end of the discharge connection path, which communicates with the pumping paths, has a larger cross-sectional area than one end of the discharge connection path which communicates with the discharge guide path.
